(19) United States
(12) Patent Application Publication
(10) Pub. No.: US 2026/0298398 A1
(43) Pub. Date: Oct. 1, 2026

(54) SUPPORT INTERFACES FOR LAND-BASED MODULARIZED ROTATING EQUIPMENT

(71) Applicant: FLUOR TECHNOLOGIES CORPORATION, Irving, TX (US)

(72) Inventor: Neetin GHAISAS, Calgary (CA)

(21) Appl. No.: 19/477,747

(22) PCT Filed: Apr. 24, 2023
(86) PCT No.: PCT/US2023/019646

§ 371 Date: Oct. 22, 2025

(51) Int. Cl. F16M 7/00; F16M 5/00

(52) U.S. Cl. CPC F16M 7/00; F16M 5/00

(57) ABSTRACT

A module for a modular industrial system includes a support structure including an elongate support member having a vertically upper surface, a piece of rotating equipment supported on the support structure, the piece of rotating equipment having a rotatable component configured to rotate about a rotational axis, a baseplate having a vertically upper surface and a vertically lower surface opposite the upper surface, wherein the piece of rotating equipment is supported on the upper surface of the baseplate, and a support interface coupled between the lower surface of the baseplate and the upper surface of the support member and including a self-leveling chock defining a first longitudinal axis and a second longitudinal axis pivotable relative to the first longitudinal axis to maintain the first longitudinal axis in a vertical orientation.

### CROSS-REFERENCE TO RELATED APPLICATIONS

Not applicable.

STATEMENT REGARDING FEDERALLY SPONSORED RESEARCH OR DEVELOPMENT

Not applicable.

### BACKGROUND

Modular industrial systems or “plants” are utilized in a variety of industrial applications including the transportation and processing of various types of fluids using stationary and rotating equipment. Conventionally, industrial systems have been “stick-built” whereby the industrial system is generally built on location per the specifications of the given industrial application. For instance, a process system or plant may be stick-built on location whereby all of the components and associated equipment comprising the process system are built and assembled at the intended location of the process system. This may involve constructing bespoke foundations and correspond above-grade steel support structures at the intended location such that the constructed foundations and support structures permanently remain at the intended location (which may be a remote location that is difficult to access and/or may have other issues limiting convenience of use) for the lifespan of the process system, following which the foundations and support structures may be decommissioned and torn down. Stationary equipment and rotating equipment such as dynamic compressor strings (along with any other remaining equipment) may be installed at the intended location following construction of the foundation and support structures to complete construction of the stick-built process system. This process may be expensive, lengthy, labor-intensive and hazardous with the requirement that much of the equipment of the process system needing to be assembled on location instead of on a shop floor or module yard in a controlled environment. Additionally, much of the equipment comprising the stick-built process system was designed and built specifically for the given process system, and cannot be reused at a second process system in order to defray costs associated with building the equipment.

### SUMMARY

An embodiment of a module for a modular industrial system comprises a support structure comprising an elongate support member having a vertically upper surface, a piece of rotating equipment supported on the support structure, the piece of rotating equipment having a rotatable component configured to rotate about a rotational axis, a baseplate having a vertically upper surface and a vertically lower surface opposite the upper surface, wherein the piece of rotating equipment is supported on the upper surface of the baseplate, and a support interface coupled between the lower surface of the baseplate and the upper surface of the support member and comprising a self-leveling chock defining a first longitudinal axis and a second longitudinal axis pivotable relative to the first longitudinal axis to maintain the first longitudinal axis in a vertical orientation. In some embodiments, the piece of rotating equipment comprises one or more support feet contacting and coupled to the upper surface of the baseplate. In some embodiments, the support interface further comprises a mounting pad positioned between the self-leveling chock and the lower surface of the baseplate. In some embodiments, the mounting pad comprises a vertically upper surface machined to a flatness of 0.001 inches. In some embodiments, at least a portion of the upper surface of the support member is machined to a flatness of 0.001 inches. In some embodiments, the self-leveling chock comprises a first washer having a first frustoconical surface and a second washer having a second frustoconical surface in sliding contact with the first frustoconical surface. In some embodiments, the module comprises a fastener extending through the self-leveling chock and the baseplate to secure the support interface to the lower surface of the baseplate.

An embodiment of a module for a modular industrial system comprises a support structure comprising an elongate support member having a vertically upper surface, a piece of rotating equipment supported on the support structure, the piece of rotating equipment having a rotatable component configured to rotate about a rotational axis, a baseplate having a vertically upper surface and a vertically lower surface opposite the upper surface, wherein the piece of rotating equipment is supported on the upper surface of the baseplate, a support interface coupled between the lower surface of the baseplate and the upper surface of the support member and comprising a self-leveling chock comprising a first washer having a first frustoconical surface and a second washer having a second frustoconical surface in sliding contact with the first frustoconical surface. In some embodiments, the piece of rotating equipment comprises one or more support feet contacting and coupled to the upper surface of the baseplate. In some embodiments, the support interface further comprises a mounting pad positioned between the self-leveling chock and the lower surface of the baseplate. In some embodiments, the mounting pad comprises a vertically upper surface machined to a flatness of 0.001 inches. In some embodiments, at least a portion of the upper surface of the support member is machined to a flatness of 0.001 inches. In some embodiments, the first washer comprises a first planar surface opposite the first frustoconical surface and the second washer comprises a second planar surface opposite the second frustoconical surface.

An embodiment of a module for a modular industrial system comprises a support structure comprising an elongate support member having a vertically upper surface, a piece of rotating equipment supported on the support structure, the piece of rotating equipment having a rotatable component configured to rotate about a rotational axis, a baseplate having a vertically upper surface and a vertically lower surface opposite the upper surface, wherein the piece of rotating equipment is supported on the upper surface of the baseplate, a support interface coupled between the lower surface of the baseplate and the upper surface of the support member and comprising a mounting pad contacting the lower surface of the baseplate and a self-leveling chock contacting the upper surface of the support member wherein the self-leveling chock is configured to maintain planar contact between the mounting pad and the lower surface of the baseplate and planar contact between the self-leveling chock and the upper surface of the support member. In some embodiments, the piece of rotating equipment comprises one or more support feet contacting and coupled to the upper surface of the baseplate. In some embodiments, the mounting pad comprises a vertically upper surface machined to a flatness of 0.001 inches. In some embodiments, at least a portion of the upper surface of the support member is machined to a flatness of 0.001 inches. In some embodiments, the self-leveling chock defining a first longitudinal axis and a second longitudinal axis pivotable relative to the first longitudinal axis to maintain the first longitudinal axis in a vertical orientation. In some embodiments, the self-leveling chock comprises a first washer having a first frustoconical surface and a second washer having a second frustoconical surface in sliding contact with the first frustoconical surface. In some embodiments, the first washer comprises a first planar surface opposite the first frustoconical surface and the second washer comprises a second planar surface opposite the second frustoconical surface.

### BRIEF DESCRIPTION OF THE DRAWINGS

For a detailed description of various exemplary embodiments, reference will now be made to the accompanying drawings in which:

FIG. 1 is a schematic view of an embodiment of a modular industrial system in accordance with principles described herein;

FIG. 2 is a side view of an embodiment of a module of the modular industrial system of FIG. 1 in accordance with principles described herein;

FIG. 3 is a zoomed-in side view of an embodiment of a support foot of the module of FIG. 2; and

FIG. 4 is a side view of an embodiment of a support interface of the module of FIG. 2 in accordance with principles described herein.

### DETAILED DESCRIPTION OF EXEMPLARY DISCLOSED EMBODIMENTS

The following discussion is directed to various exemplary embodiments. However, one of ordinary skill in the art will understand that the examples disclosed herein have broad application, and that the discussion of any embodiment is meant only to be exemplary of that embodiment, and not intended to suggest that the scope of the disclosure, including the claims, is limited to that embodiment. The drawing figures are not necessarily to scale. Certain features and components herein may be shown exaggerated in scale or in somewhat schematic form.

In the following discussion and in the claims, the terms “including” and “comprising” are used in an open-ended fashion, and thus should be interpreted to mean “including, but not limited to . . . ” . Also, the term “couple” or “couples” is intended to mean either an indirect or direct connection. Thus, if a first device couples to a second device, that connection may be through a direct connection of the two devices, or through an indirect connection that is established via other devices, components, nodes, and connections. In addition, as used herein, the terms “axial” and “axially” generally mean along or parallel to a given axis (e.g., central axis of a body or a part), while the terms “radial” and “radially” generally mean perpendicular to the given axis. For instance, an axial distance refers to a distance measured along or parallel to the axis, and a radial distance means a distance measured perpendicular to the axis. As used herein, the terms “approximately,” “about,” “substantially,” and the like mean within 10% (i.e., plus or minus 10%) of the recited value. Thus, for example, a recited angle of “about 80 degrees” refers to an angle ranging from 72 degrees to 88 degrees. Further, unless the context dictates the contrary, all ranges set forth herein should be interpreted as being inclusive of their endpoints, and open-ended ranges should be interpreted to include only commercially practical values. Similarly, all lists of values should be considered as inclusive of intermediate values unless the context indicates the contrary.

As previously described above, conventionally, industrial systems are stick-built on-location in a manner that can be hazardous to the personnel tasked with assembling the industrial system given the uncontrolled and potentially hazardous nature of the onsite location, as well as expensive given the fact that much of the equipment used in building the stick-built industrial system is specifically design and built for the given industrial system, and thus cannot be easily reused in future applications to defray costs associated with the construction of the equipment.

In order to address some of the issues associated with stick-built industrial systems, some operators of industrial systems have begun employing so called “modular” industrial systems formed from general purpose (rather than bespoke) components or modules which may be originally built in a controlled environment and later transported to the intended location of the industrial system. Once on-location, the modules are set on their foundations and may be connected together to thereby form the desired industrial system at the intended location in a manner that minimizes the assembly and construction work performed at the intended location. Additionally, the modules forming the industrial system, following the conclusion of the industrial application in which the system is engaged and in the interest of defraying costs associated with their original construction, may be disconnected from each other and redressed whereby the redressed modules may be reused in a future industrial system located at another intended location different from the first. Further, given that the modules are not specifically tailored for one given industrial application, a large number of modules may be manufactured for use with different and varying industrial applications.

While modular industrial systems address some of the issues associated with stick-built industrial systems as outlined above, modular industrial systems present new challenges not present with conventional stick-built industrial systems. Particularly, the modules are typically positioned on the terrain defining the intended location of the industrial system without being connected to an underlying continuous foundation (e.g., an underlying continuous foundation block). While avoiding the requirement of constructing a foundation at the intended location may minimize the overall time and costs required for constructing the modular industrial system, the lack of a continuous and rigid concrete foundation presents new and additional challenges with respect to providing adequate structural support to the equipment of the modules of the modular industrial system.

Particularly, at least some of the equipment forming the modular industrial system, such as rotating equipment, may be sensitive to flexure of the support structure physically supporting the rotating equipment. As one example, dynamic-type compressors and their drivers, herein referred to as dynamic compressor strings dynamic compressor strings, may be particularly sensitive to deflections of the support structure and vibrations conducted through the support structure forming the modules of the modular industrial system. Additionally, the structural steel forming the structural supports of the modular industrial system typically is generally less stiff than the typical concrete foundations used in stick-built industrial systems and provides less damping than the materials forming the continuous foundation (e.g., concrete) of conventional stick-built industrial systems. Thus, the structural response of the support structures of modular industrial systems to vibration (e.g., vibration from the operation of rotating equipment) is different from the structural response of the support structures of stick-built industrial systems supported by an underlying continuous foundation.

Conventionally, industrial equipment, such as rotating equipment, is attached to the structural support of a given module of a modular industrial system using stainless steel shims positioned at a support interface formed between a baseplate of the industrial equipment and the support structure for coupling the industrial equipment to the support structure in a manner that ensures the industrial equipment is level. However, the process of inserting the shims at the support interface is typically time consuming and labor intensive. Additionally, the shims are not easily adjusted following their initial installation.

Moreover, given that the structural steel forming the structural support is not as rigid as a continuous concrete foundation, the structural support is subjected to natural sag whereby the structural support may deflect in the vertical direction by more than 0.001 inches per foot (in/ft) in at least some applications. This natural sag of the structural support alters the contact between the baseplate of the industrial equipment and the structural support which may permit the transmission of vibration from the baseplate of the industrial equipment to the structural support. In this manner, vibrations other than vibrations intentionally monitored by monitoring equipment (e.g., radial vibrations produced by rotating components of the industrial equipment) may be picked up inadvertently by the monitoring equipment, potentially resulting in the industrial equipment inadvertently being tripped by the monitoring equipment resulting in an unnecessary shutdown of the industrial equipment and a loss of production from the modular industrial system. To state in other words, the undesirable transmission of vibration across the support interface may inadvertently cause the industrial equipment to trip through the sensing of spurious vibrational signals by monitoring equipment associated with the given industrial equipment, resulting in an unnecessary shutdown of the industrial equipment.

Accordingly, embodiments of support interfaces for modularized rotating equipment, including modularized dynamic compressor strings, are described herein for minimizing the transmission of vibration through the support interface which may otherwise result from imperfect contact between the support interface and the accompanying support structure. Particularly, embodiments of support interfaces described herein include a self-leveling chock defining a first longitudinal axis and a second longitudinal axis pivotable relative to the first longitudinal axis to maintain the first longitudinal axis in a vertical orientation. The support interface may additionally include a mounting pad (e.g., a machined mounting pad) where the self-leveling chock is configured to maintain planar contact between the mounting pad and a lower surface of a baseplate supporting rotating equipment and planar contact between the self-leveling chock and an upper surface of a support member of the support structure. As used herein, the term “planar contact” is defined as contact between two opposing surfaces oriented parallel to each other such that the opposing surfaces are not oriented at non-zero angles relative to each other. Additionally, the self-leveling chock may include a first washer having a first frustoconical surface and a second washer having a second frustoconical surface in sliding contact with the first frustoconical surface to maintain said planar contact.

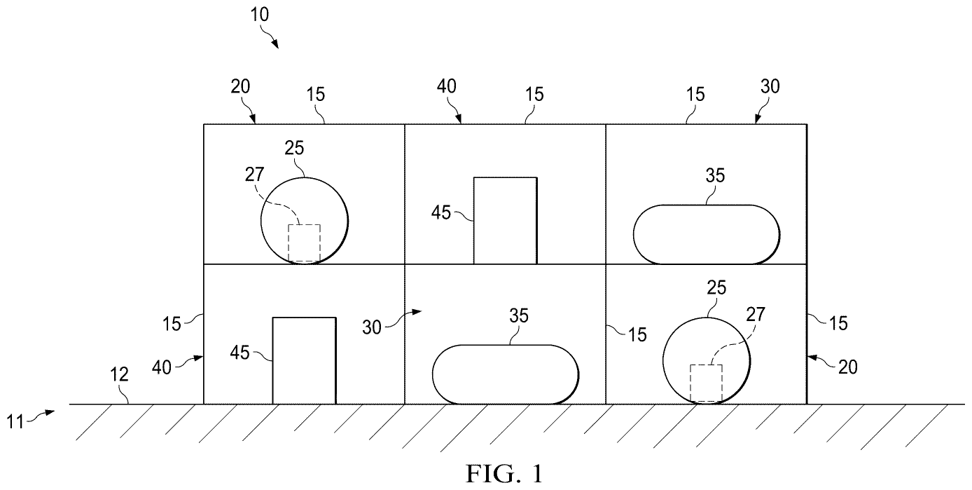

Referring to FIG. 1, an embodiment of a modular industrial system 10 is shown. Modular industrial system 10 may be used to accomplish a variety of industrial applications including, for example, the transportation and processing of various fluids. In this exemplary embodiment, modular industrial system 10 generally includes a plurality of modules 20, 30, and 40 assembled together at the intended location 11 of the modular industrial system 10. It may be noted that modular industrial system 10 does not include a continuous foundation positioned beneath the modules 20, 30, and 40 for providing structural support thereto, and instead, modules 20, 30, and 40 are supported by directly by the ground 12 of the intended location 11.

In this exemplary embodiment, each module 20, 30, and 40 comprises a portable support structure 15 and different modularized industrial equipment 25, 35, and 45 supported by the support structure 15 of the module 20, 30, and 40 at a support interface as will be described further herein. For example, industrial equipment 25 may comprise one or more pieces of rotating equipment and thus may also be referred to herein as rotating equipment 25. In this exemplary embodiment, rotating equipment 25 generally comprises a dynamic compressor string; however, it may be understood that in other embodiments rotating equipment 25 may comprise any type of equipment having a component that rotates about a rotational axis such as, for example, centrifugal pumps, compressors (e.g., centrifugal fans, centrifugal blowers, compressor strings or trains having a single or multiple casings and with or without gears), and other rotating equipment such as electric motors, steam turbines or gas turbine drivers. In this exemplary embodiment, rotating equipment 25 comprises monitoring equipment 27 configured to monitor one or more specific parameters of the rotating equipment 25, including one or more specific vibrations generated by the rotating equipment 25 during operation. For example, monitoring equipment 27 may include one or more radial vibration probes attached to the rotating equipment 25 at specific locations for monitoring specific vibrations indicative of the current status or health of the rotating equipment 25. The monitoring equipment 27 may be configured to automatically trip or shutdown the rotating equipment 25 should one of these specific monitored vibrations exceed a predefined threshold.

In addition to rotating equipment 25 of modules 20, modular industrial system 10 additionally includes industrial equipment 35 of modules 30 and industrial equipment 45 of the modules 40 of system 10. In this exemplary embodiment, industrial equipment 35 comprises one or more heat exchangers while industrial equipment 45 comprises one or more tanks or pressure vessels. Modules 20, 30, and 40 are conveniently constructed and assembled at locations remote from the intended location 11 of the modular industrial system 10, such as one or more controlled environments (e.g., one or more shops or module yards). The constructed modules 20, 30, and 40 are then transported (e.g., via truck, rail, ship) to the intended location 11 where the modules 20, 30, and 40 are assembled together to form the modular industrial system 10 or are set individually on their respective foundation supports. As shown in FIG. 1, in the interest of minimizing costs associated with constructing the modular industrial system 10, modules 20, 30, and 40 are supported directly by the ground 12, and not by an underlying foundation previously constructed at the intended location 11. Following their transportation to the intended location 11, the industrial equipment 25, 35, and 45 of the modules 20, 30, and 40 are fluidically connected together via a plurality of fluid conduits connected between the various modules 20, 30, and 40 of modular industrial system 10.

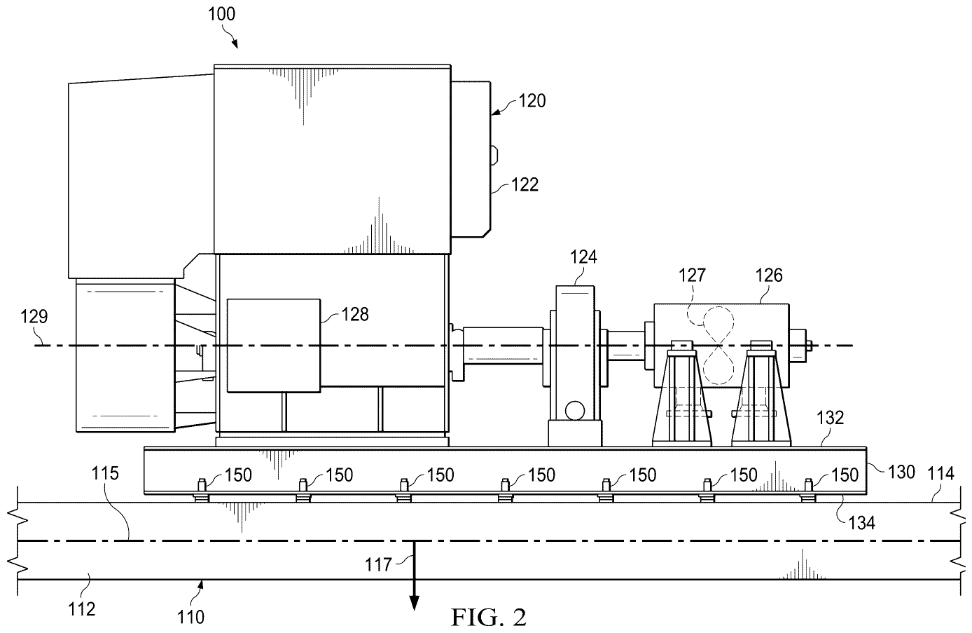

Referring to FIGS. 2-4, an embodiment of a module 100 of a modular industrial system is partially shown. Module 100 generally includes a support structure 110 and industrial equipment in the form of modularized rotating equipment 120. In this exemplary embodiment, support structure 110 comprises an elongate support member or beam 112 having a central or longitudinal axis 115 and defining a first or upper support surface 114 against which the rotating equipment 120 is supported. It may be understood, however, that in other embodiments the shape and geometry of support beam 112 may vary from that shown in FIGS. 2-4. Additionally, it may be understood that support structure 110 may comprise components and features in addition to the support beam 112 shown in FIGS. 2-4.

The rotating equipment 120 of module 100 include a motor or prime mover 122 (e.g., an electric motor, a gas turbine, a steam turbine, a gearbox 124, and a driven centrifugal or an axial compressor 126. Rotating equipment 120 additionally includes an elongate baseplate 130 that physically supports the prime mover 122, gearbox 124, and compressor 126 of the rotating equipment 120. Compressor 126 includes one or more rotatable components 127 (e.g., compressor impellers) rotatable about a rotational axis 129 of the compressor 126. Additionally, rotating equipment 120 comprises monitoring equipment 128 for monitoring one or more parameters of the rotating equipment 120. While in this exemplary embodiment rotating equipment 120 comprises compressor 126 including gearbox 124, it may be understood that the configuration of rotating equipment 120 may vary from that shown in FIGS. 2-4. For example, in other embodiments, rotating equipment 120 may comprise a compressor that does not include a gearbox 124, and instead the driven compressor may be directly coupled to variable-speed driver such as steam turbine or gas turbine.

The baseplate 130 extends longitudinally along a central or longitudinal axis extending parallel to the rotational axis 129 of compressor 126. In this exemplary embodiment, baseplate 130 of rotating equipment 120 has a first or vertically upper support surface 132 against which the prime mover 122, gearbox 124, and compressor 126 are supported, and a second or vertically lower support surface 134 opposite the upper support surf 132. Additionally, baseplate 130 comprises a traverse member 136 which extends vertically between the support surfaces 132 and 134 of baseplate 130 whereby baseplate 130 comprises an I-beam having an I-shaped cross-section. It may be understood, however, that in other embodiments the shape and geometry of support beam 112 may vary from that shown in FIGS. 2-4. Additionally, it may be understood that support structure 111 may comprise components and features in addition to the support beam 112 shown in FIGS. 2-4.

Positioned between the lower support surface 134 of the baseplate 130 of rotating equipment 120 and the upper support surface 114 of the support beam 112 of support structure 110 are a plurality of support interfaces 150. Particularly, support interfaces 150 are spaced along the lower support surface 134 of baseplate 130 whereby the support interfaces 150 each couple directly to both the lower support surface 134 of baseplate 130 and the upper support surface 114 of support beam 112. It may be understood that the number of support interfaces 150 may vary in other embodiments from that shown in FIG. 2 including, in at least some embodiments, only a single support interface 150. The support interfaces 150 couple the rotating equipment 120 to the support beam 112 of support structure 110 whereby structural and other loads are transferred from the rotating equipment 120 to the support structure 110, and ultimately from the support structure 110 to the ground on which the module 100 is positioned. As will be discussed further herein, support interfaces 150 are configured to minimize or attenuate vibration transmitted between the rotating equipment 120 and the support beam 112 of support structure 110.

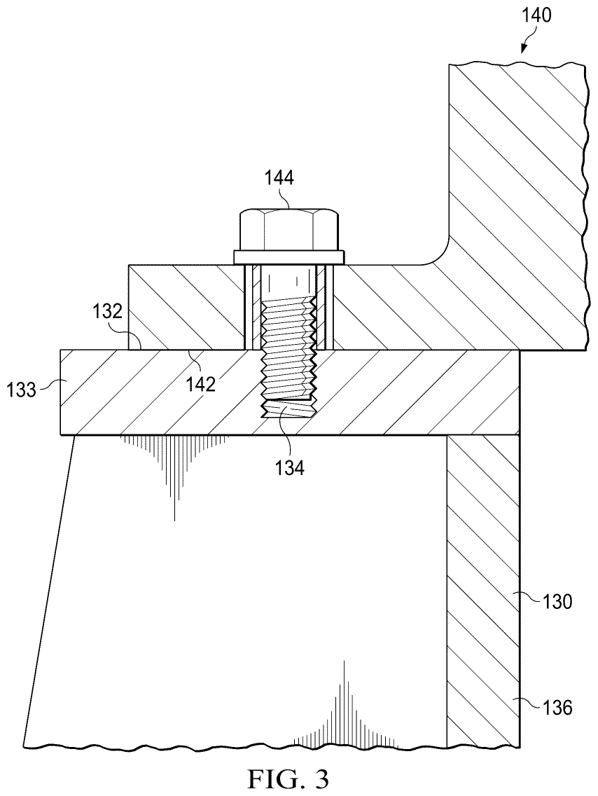

As shown particularly in FIG. 3, the upper support surface 132 of baseplate 130 couples to at least one of the support feet 140 (referred to as support foot 140 below) attached directly to the prime mover 122, gearbox 124, and compressor 126. Particularly, in this exemplary embodiment, a vertically lower support surface 142 of the support foot 140 is positioned against a mounting pedestal 133 of the baseplate 130, where the pedestal 133 defines at least a portion of the upper support surface 132 of the baseplate 130. A fastener 144 extends through both the lower support surface 142 of the support foot 140 and the upper support surface 132 of baseplate 130 whereby a terminal end of the fastener 144 is received in a receptacle 134 formed in the pedestal 133. In this exemplary embodiment, fastener 144 threadably connects (e.g., via threads formed on an inner surface of the receptacle 134) the support foot 140 to the pedestal 133 of baseplate 130. It may be understood that fastener 144 does not provide significant damping of vibrations communicated either from the baseplate 130 to the equipment positioned thereon (e.g., prime mover 122, gearbox 124, and compressor 126) or from the equipment to the baseplate 130. In this exemplary embodiment, fastener 144 is only meant to facilitate the coupling of the equipment to the baseplate 130.

As previously described, the support structure 110 of module 100 is not supported by a continuous foundation (e.g., a concrete foundation) positioned beneath the module 100. In this configuration, the central axis 115 of support beam 112 is permitted to deflect or sag vertically as indicated by arrow 117 in FIG. 2. The vertical deflection 117 results in the curving of central axis 115 whereby the upper support surface 114 correspondingly curves in concert with central axis 115. In this manner, upper support surface 114 does not define a two-dimensional (2D) plane and instead defines a concave curve. The curvature of the upper support surface 114 of support beam 112 alters the contact formed between support interfaces 150 and the upper support surface 114 of support beam 112 whereby stray vibrations (vibrations not specifically monitored by monitoring equipment 128) may be undesirably transmitted across support interfaces 150 unless these stray vibrations are effectively dampened and attenuated by the support interfaces 150 themselves.

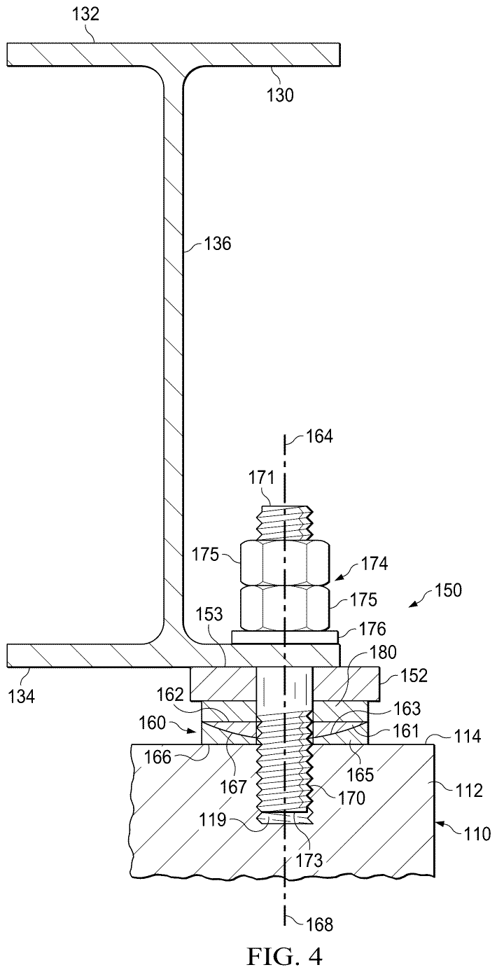

An embodiment of one of the support interfaces 150 is shown particularly in FIG. 4. In this exemplary embodiment, support interface 150 generally includes a machined mounting pad 152, an engineered self-leveling chock 160, and a fastener 170. Mounting pad 152 has a first or vertically upper engagement surface 153 that contacts the lower surface 134 of the baseplate 130 of modularized rotating equipment 120 (shown in FIGS. 1 and 2). The engagement surface 153 of mounting pad is machined to form a planar surface for contacting the lower surface 134 of the baseplate 130. For example, in this exemplary embodiment, engagement surface 153 is machined to a flatness of 0.001 inches) with a surface finish of 250 micro-inches) to ensure near-full surface-to-surface contact between the mounting pad 152 and the baseplate 130 along a flat, horizontally extending plane. In some embodiments, at least 90% of the engagement surface 153 contacts the baseplate 130 along the horizontally extending plane. It may be understood that near-full contact between the support interface and both the baseplate 130 and the support beam 112 facilitates a minimization of the transmission of vibration across the support interface 150 between the baseplate 130 and the support beam 112.

Further, in this exemplary embodiment, the upper surface 114 of the support beam is also machined in a manner consistent with the machining of the engagement surface 153 of mounting pad 152. Additionally, in this exemplary embodiment, mounting pad 152 is formed from austenitic stainless steel; however, it may be understood that the material forming mounting pad 152 may vary in other embodiments. In this exemplary embodiment, he upper surface 114 of support beam 112 is machined to a flatness of 0.001 inches with a surface finish of 50 micro-inches to ensure near-full contact between the support beam 112 and the self-leveling chock 160 of support interface 150 along a flat, horizontally extending plane.

The self-leveling chock 160 ensures the mounting pad 152 is maintained level with the horizontal (e.g., level to the ground upon which module 100 is positioned) whereby the mounting pad 152 extends horizontally relative to the ground irrespective of sag (e.g., deflection 117 shown in FIG. 2) in the support beam 112 which may orient the upper surface 114 of support beam 112 in a non-level orientation extending at a non-zero angle to the horizontal. In this exemplary embodiment, self-leveling chock 160 comprises an engineered steel chock. Additionally, in this exemplary embodiment, self-leveling chock 160 generally includes an annular first or vertically upper washer 161 and an annular second or vertically lower washer 165. Upper washer 161 includes a flat or planer vertically upper engagement surface 162 and a vertically lower frustoconical surface 163 opposite the engagement surface 162. Lower washer 165 includes a vertically upper frustoconical surface 166 and a flat or planer vertically lower engagement surface 167 opposite the frustoconical surface 166. In some embodiments, washers 161 and 165 are each formed from a steel alloy such as austenitic steel. Additionally, in this exemplary embodiment, the support interface 150 additionally includes a convex washer 180 positioned between the mounting pad 152 and the washer 161 of self-leveling chock 160.

The frustoconical surfaces 163 and 166 of washers 161 and 165 are in sliding contact with each other to ensure the engagement surface 162 of upper washer 161 remains level with the horizontal even when the engagement surface 167 of lower washer 165. Particularly, upper washer 161 has a first or upper longitudinal axis 164 while the lower washer 165 has a second or lower longitudinal axis 168 that is parallel or coaxial with upper longitudinal axis 164 when both engagement surfaces 162 and 167 are level with the horizontal (as shown in FIG. 4). However, sliding contact between frustoconical surfaces 163 and 166 of washers 161 and 165 permits the lower longitudinal axis 168 to pivot relative to the upper longitudinal axis 164 whereby the lower longitudinal axis 168 extends at a non-zero angle relative to the upper longitudinal axis 164. Particularly, lower washer 165 may slide relative to upper washer 161 pivoting lower longitudinal axis 168 into an orientation forming a non-zero angle with upper longitudinal axis 164 in response to sagging of the support beam 112 whereby the upper surface 114 of support beam 112 is no longer level with the horizontal. In this manner, the upper longitudinal axis 164 of upper washer 161 may be maintained in a vertical orientation extending orthogonal to the horizontal even when lower longitudinal axis 168 is oriented at a non-zero angle to the vertical (e.g., is not oriented orthogonal to the horizontal and instead is oriented at an acute angle to the horizontal).

By permitting the lower washer 165 to pivot in concert with the support beam 112 in response to sagging of the support beam 112, the engagement surface 167 of lower washer 165 may be maintained in planar contact with the upper surface 114 of support beam 112 even if support beam 112 sags. Additionally, by permitting the pivoting of lower washer 165 relative to upper washer 161, the engagement surface 162 of upper washer 161 may likewise be maintained in planar contact with the lower surface 134 of baseplate 130.

Moreover, the engagement surface 153 of mounting pad 152 may likewise be maintained in planar contact with the lower surface 134 of baseplate 130 with the upper longitudinal axis 164 maintained in a vertical orientation orthogonal to the horizontal. The maintaining of planar contact between mounting pad 152 and baseplate 130 and between lower washer 165 and support beam 112 minimizes the transmission of vibration across support interface 150. As described above, the minimization of the transmission of vibration across support interface 150 may prevent the inadvertent tripping of the rotating equipment 120 by monitoring equipment 128 in response to the monitoring equipment 128 inadvertently detecting stray vibrations transmitted across the support interface 150. Additionally, in this manner, the equipment supported by baseplate 130 (e.g., prime mover 122, gearbox 124, and compressor 126) may be maintained level under dynamic loads, with the horizontal even as the underlying support beam 112 of support structure 110 sags.

It may be understood that support interfaces 150 may not simply be transferred from their positions between the baseplate 130 and support beam 112 to an alternative position located between the support foot 140 and baseplate 130 while still providing the same vibration damping functionality given that such a modification would result in the transmission of vibrations between the sagging support beam 112 and the baseplate 130, where vibrations in the baseplate 130 ultimately being transferred to the equipment supported thereon irrespective of the presence of support interfaces 150 between the baseplate 130 and the mounting feet 140 of the supported equipment.

As shown particularly in FIG. 4, the fastener 170 of support interface 150 extends centrally therethrough between a first or vertically upper end 171 and a second or vertically lower end 173 opposite the upper end 171 of fastener 170. In this exemplary embodiment, the lower end 173 of fastener 170 is received in a receptacle 119 formed in the upper surface 114 of support beam 112 whereby the lower end 173 of fastener 170 threadably connects to the support beam 112 to attach the fastener 170 to the support beam 112. Additionally, in this exemplary embodiment, the upper end 171 of fastener 170 is threaded to a double lock nut assembly 174 to secure the fastener 170 to the baseplate 130. The double lock nut assembly 174 includes a pair of lock nuts 175 threaded to the upper end 171 of fastener 170 and a washer 176 positioned against the baseplate 130. While in this exemplary embodiment fastener 170 and lock nut assembly 174 are used to attach or secure the support interface 150 to the baseplate 130 and the support beam 112, it may be understood that in other embodiments a variety of different mechanisms may be used for securing the support interface 150 to the baseplate 130 and support beam 112.

While exemplary embodiments have been shown and described, modifications thereof can be made by one skilled in the art without departing from the scope or teachings herein. The embodiments described herein are exemplary only and are not limiting. Many variations and modifications of the systems, apparatus, and processes described herein are possible and are within the scope of the disclosure. Accordingly, the scope of protection is not limited to the embodiments described herein, but is only limited by the claims that follow, the scope of which shall include all equivalents of the subject matter of the claims. Unless expressly stated otherwise, the steps in a method claim may be performed in any order. The recitation of identifiers such as (a), (b), (c) or (1), (2), (3) before steps in a method claim are not intended to and do not specify a particular order to the steps, but rather are used to simplify subsequent reference to such steps.

What is claimed is:

1. A module for a modular industrial system, the module comprising:
a support structure comprising an elongate support member having a vertically upper surface;
a piece of rotating equipment supported on the support structure, the piece of rotating equipment having a rotatable component configured to rotate about a rotational axis;
a baseplate having a vertically upper surface and a vertically lower surface opposite the upper surface, wherein the piece of rotating equipment is supported on the upper surface of the baseplate; and
a support interface coupled between the lower surface of the baseplate and the upper surface of the support member and comprising a self-leveling chock defining a first longitudinal axis and a second longitudinal axis pivotable relative to the first longitudinal axis to maintain the first longitudinal axis in a vertical orientation.

2. The module of claim 1, wherein the piece of rotating equipment comprises one or more support feet contacting and coupled to the upper surface of the baseplate.

3. The module of claim 1, wherein the support interface further comprises a mounting pad positioned between the self-leveling chock and the lower surface of the baseplate.

4. The module of claim 3, wherein the mounting pad comprises a vertically upper surface machined to a flatness of 0.001 inches.

5. The module of claim 1, wherein at least a portion of the upper surface of the support member is machined to a flatness of 0.001 inches.

6. The module of claim 1, wherein the self-leveling chock comprises a first washer having a first frustoconical surface and a second washer having a second frustoconical surface in sliding contact with the first frustoconical surface.

7. The module of claim 1, further comprising a fastener extending through the self-leveling chock and the baseplate to secure the support interface to the lower surface of the baseplate.

8. A module for a modular industrial system, the module comprising:
a support structure comprising an elongate support member having a vertically upper surface;
a piece of rotating equipment supported on the support structure, the piece of rotating equipment having a rotatable component configured to rotate about a rotational axis;
a baseplate having a vertically upper surface and a vertically lower surface opposite the upper surface, wherein the piece of rotating equipment is supported on the upper surface of the baseplate; and
a support interface coupled between the lower surface of the baseplate and the upper surface of the support member and comprising a self-leveling chock comprising a first washer having a first frustoconical surface and a second washer having a second frustoconical surface in sliding contact with the first frustoconical surface.

9. The module of claim 8, wherein the piece of rotating equipment comprises one or more support feet contacting and coupled to the upper surface of the baseplate.

10. The module of claim 8, wherein the support interface further comprises a mounting pad positioned between the self-leveling chock and the lower surface of the baseplate.

11. The module of claim 10, wherein the mounting pad comprises a vertically upper surface machined to a flatness of 0.001 inches.

12. The module of claim 8, wherein at least a portion of the upper surface of the support member is machined to a flatness of 0.001 inches.

13. The module of claim 8, wherein the first washer comprises a first planar surface opposite the first frustoconical surface and the second washer comprises a second planar surface opposite the second frustoconical surface.

14. A module for a modular industrial system, the module comprising:
a support structure comprising an elongate support member having a vertically upper surface;
a piece of rotating equipment supported on the support structure, the piece of rotating equipment having a rotatable component configured to rotate about a rotational axis;
a baseplate having a vertically upper surface and a vertically lower surface opposite the upper surface, wherein the piece of rotating equipment is supported on the upper surface of the baseplate; and
a support interface coupled between the lower surface of the baseplate and the upper surface of the support member and comprising a mounting pad contacting the lower surface of the baseplate and a self-leveling chock contacting the upper surface of the support member wherein the self-leveling chock is configured to maintain planar contact between the mounting pad and the lower surface of the baseplate and planar contact between the self-leveling chock and the upper surface of the support member.

15. The module of claim 14, wherein the piece of rotating equipment comprises one or more support feet contacting and coupled to the upper surface of the baseplate.

16. The module of claim 14, wherein the mounting pad comprises a vertically upper surface machined to a flatness of 0.001 inches.

17. The module of claim 14, wherein at least a portion of the upper surface of the support member is machined to a flatness of 0.001 inches.

18. The module of claim 14, wherein the self-leveling chock defining a first longitudinal axis and a second longitudinal axis pivotable relative to the first longitudinal axis to maintain the first longitudinal axis in a vertical orientation.

19. The module of claim 14, wherein the self-leveling chock comprises a first washer having a first frustoconical surface and a second washer having a second frustoconical surface in sliding contact with the first frustoconical surface.

20. The module of claim 19, wherein the first washer comprises a first planar surface opposite the first frustoconical surface and the second washer comprises a second planar surface opposite the second frustoconical surface.
